(19) United States
(12) Patent Application Publication
(10) Pub. No.: US 2022/0339834 A1
(43) Pub. Date: Oct. 27, 2022

(54) METHOD FOR MANUFACTURING A TOOTHED WHEEL BY COMPRESSION INJECTION MOLDING

(71) Applicant: JTEKT EUROPE, Irigny (FR)

(72) Inventors: Jean-Noel PAQUIEN, Mions (FR); Damien JACQUET, Lyon (FR); Roch MONNET, Brindas (FR); Michel KAMGA NGUEMDJOM, Villeurbanne (FR)

(73) Assignee: JTEKT EUROPE, Irigny (FR)

(21) Appl. No.: 17/730,458

(22) Filed: Apr. 27, 2022

(30) Foreign Application Priority Data
Apr. 27, 2021 (FR) 21/04366

(51) Int. Cl. B29C 45/56; B29C 45/16; B29C 45/26; B29C 45/23

(52) U.S. Cl. CPC B29C 45/561; B29C 45/16; B29C 45/26; B29C 45/23; B29L 2015/00

(57) ABSTRACT

A method for manufacturing a wheel, the method including a step of making a rim on a radially outer peripheral edge of a carrier core, during the step said carrier core, which extends from a radially inner wall forming a steering axis bore corresponding to the axis of rotation of the wheel, until the peripheral edge, is placed in a mold formed by at least one first portion and one second portion, then an injection material is injected by means of at least one injection nozzle so as to coat, by overmolding, at least partially said carrier core in order to form the rim, wherein after the injection of the injection material, the first portion of the mold and the second portion of the mold are brought closer to each other such that the injection material is compressed in the mold.

The invention concerns the field of the manufacture of wheels intended to ensure the transmission of a torque within a mechanism, and more particularly the field of the manufacture of toothed wheels intended for the gear type mechanisms.

The present invention concerns more particularly the manufacture of toothed wheels intended for the power steering reduction gears for motor vehicles. There is a known manufacturing method described in the document WO 2015/162388, in which a hub, which may for example be a sleeve or a shaft, is placed in a mold, on which an overmolding of a carrier core is carried out and then an overmolding of a rim on said carrier core is carried out. The meshing teeth of the wheel are then made in the rim.

The overmolding of the rim is carried out by means of an overmolding method implementing a main injection nozzle which is either positioned at the level of a central injection point, that is to say along the steering axis of the wheel, or connected to secondary injection nozzles placed radially offset as described in patent EP2952321.

If such methods make it possible to make toothed wheels relatively easily, they may however have some drawbacks.

First of all, in the case of a central injection point, the injected material forms after cooling and solidification a cast thickness, having the shape of a disc or a cone, between the injection point and the rim. In the case of the use of secondary injection nozzles, the injected material forms after cooling and solidification a sprue between the main injection nozzle and the secondary injection nozzles. This cast thickness or sprue is an excess of material that should be eliminated by milling type re-machining. The cycle time of the manufacturing method, and its consumption of raw materials, are therefore increased.

Furthermore, one of the ways for achieving a good quality of the material injected into an area of the rim where the meshing teeth are formed consists in applying a holding pressure for a determined time period. The holding pressure is applied at the injection point. However, in the case of a central injection point, this holding pressure is only partially transmitted to said area of the rim, due on the one hand to its remoteness and on the other hand to the solidification of the material at the level of injection point. This is also the case when using secondary injection nozzles. Indeed, in this case, the holding pressure is only partially transmitted to said area of the rim, due to the remoteness of the injection points of the secondary injection nozzles relative to the main injection nozzle and to the solidification in the sprue.

Furthermore, in the case of the use of secondary injection nozzles, it is necessary to arrange a cold-drop trap in the carrier core opposite each secondary injection nozzle. This arrangement generates an excess of material and shapes that prevent the optimization of the mechanical strength and of the mass of the carrier core.

An object of the invention is to overcome all or part of the aforementioned drawbacks by providing a method for manufacturing a wheel, the method comprising a step of making a rim on a radially outer peripheral edge of a carrier core, during the step, said carrier core, which extends from a radially inner wall forming a steering axis (XX′) bore, corresponding to the axis of rotation of the wheel, until the peripheral edge, is placed in a mold formed by at least one first portion and one second portion, then an injection material is injected by means of at least one injection nozzle so as to coat, by overmolding, at least partially said carrier core in order to form the rim, characterized in that after the injection of the injection material, the first portion of the mold and the second portion of the mold are brought closer to each other so that the injection material is compressed in the mold.

The manufacture of the rim therefore comprises two distinct phases: one during which the injection material intended to form the rim is injected, and the other during which said injection material is compressed. For this purpose, during injection the first portion and the second portion of the mold are in an injection position one relative to the other. Then during compression, the first portion of the mold and the second portion of the mold are brought closer to each other such that at the completion of the compression, the first portion and the second portion of the mold are in a fully closed position one relative to the other. One of the portions of the mold may be fixed and only the complementary portion is movable, or both portions are movable.

Thus, when the mold is in the injection position, it has a large passage section which allows the injection material to be easily injected into the mold without undergoing considerable shear forces. When the mold is in the fully closed position, it applies even pressure to the injection material that has just been injected. This avoids the formation of bubbles and of porosity in the rim and improves the filling of the mold which increases geometric accuracy. Finally, the cast thickness is reduced such that a smaller amount of material is wasted.

By «axial» it should be understood a direction along the steering axis (XX′), by «radial», it should be understood a direction transverse to the steering axis (XX′).

The invention may also comprise any of the features described in the embodiments below, considered alone or in combination.

According to one embodiment, the injection nozzle comprises a shutter making it possible to clog the injection nozzle when the first portion of the mold is brought closer to the second portion of the mold.

Thus, there is no solidification of the material at the level of the injection point.

Furthermore, the injection material is conducted at the level of the injection nozzle by an injection screw. In the method according to the invention, the obturator prevents the pressure exerted on the injection material during the compression phase from causing the recoil of the injection screw.

The completion of the injection is concomitant with the start of the compression.

According to one embodiment, the first portion of the mold is brought closer to the second portion of the mold by a translational movement.

Thus the compression is carried out uniformly.

According to one embodiment, the injection nozzle has an injection point positioned along the steering axis of the bore.

Thus, the injection material is distributed from the center of the wheel to the peripheral edge evenly and without presenting weld lines.

According to one embodiment, the injection point is located opposite an injection shield intended to protect at least one area of the carrier core or of the bore.

The injection material is thus directed only towards the peripheral edge of the carrier core in order to form the rim.

According to one embodiment, the injection nozzle has at least one injection point positioned radially offset from the steering axis of the bore.

Thus, the injection nozzle may be positioned so that the injection phase does not require the use of a protective part intended to protect at least one area of the carrier core or of the bore.

According to one embodiment, the injection point is positioned opposite a trapping cavity formed in the carrier core.

Thus, there is no re-machining in order to eliminate the cold drop which would be comprised in a casting head.

According to one embodiment, the trapping cavity is formed by a blind hole dug in the carrier core, from an upper surface of said carrier core which faces the injection nozzle.

According to one embodiment, the mold comprises recesses making it possible to directly form meshing teeth on the rim.

Thus, it is no longer necessary to make said meshing teeth by a machining method.

The method according to the invention is therefore faster.

According to one embodiment, the carrier core is manufactured in one piece from a thermoplastic polymer material, by injection molding.

According to one embodiment, the rim has an axial thickness comprised between 10 and 30 mm, preferably between 15 and 25 mm.

Thus, the rim has a thickness sufficient to give it good mechanical strength.

According to one embodiment, an upper face of the carrier core which faces the injection nozzle extends radially continuously from the radially inner wall until the peripheral edge.

By «radially continuously», it should be understood a face that does not have a groove extending along the steering axis (XX′) of the wheel.

Thus, the injection material of the carrier core does not fit into grooves extending along the axis (XX′) of the carrier core. The use of such a carrier core makes it possible to reduce the amount of used injection material.

According to one embodiment, the upper face extends in a plane substantially transverse to the steering axis (XX′).

According to one embodiment, the upper face extends opposite the first portion of the mold, and a gap between the first portion of the mold and the upper face when the two portions of the mold are brought closer to each other is less than 5 mm, preferably less than 1 mm.

Thus, the injection material only serves to form the rim. The used amount of injection material is as small as possible.

According to one embodiment, the peripheral edge comprises at least one groove extending along the steering axis (XX′) of the wheel.

Thus, the grooves promote a bonding of the injection material on the carrier core.

The invention will be better understood, thanks to the description below, which relates to several embodiments according to the present invention, as non-limiting examples and explained with reference to the appended schematic drawings, in which:

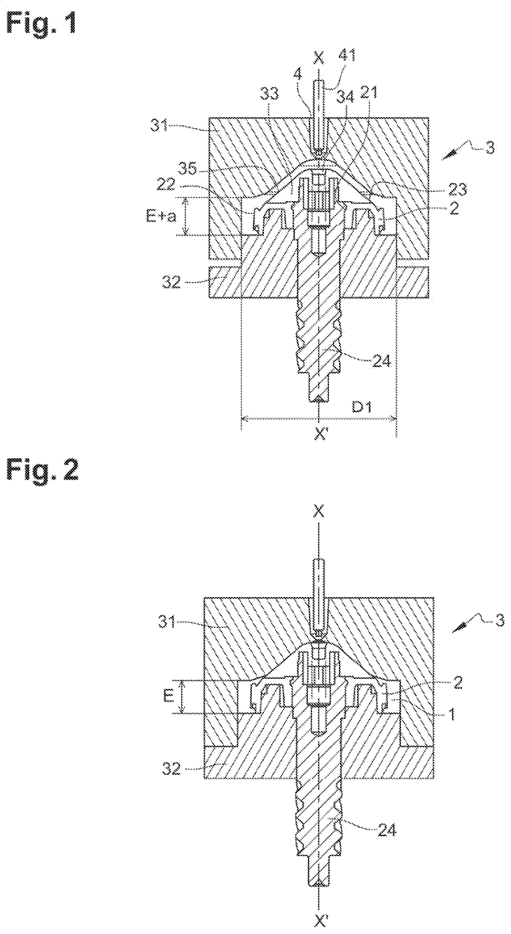

FIG. 1 is a schematic representation of a step of making a rim when an injection material is injected according to a first embodiment.

FIG. 2 is a schematic representation of the step of making a rim when the injection material of FIG. 1 is compressed.

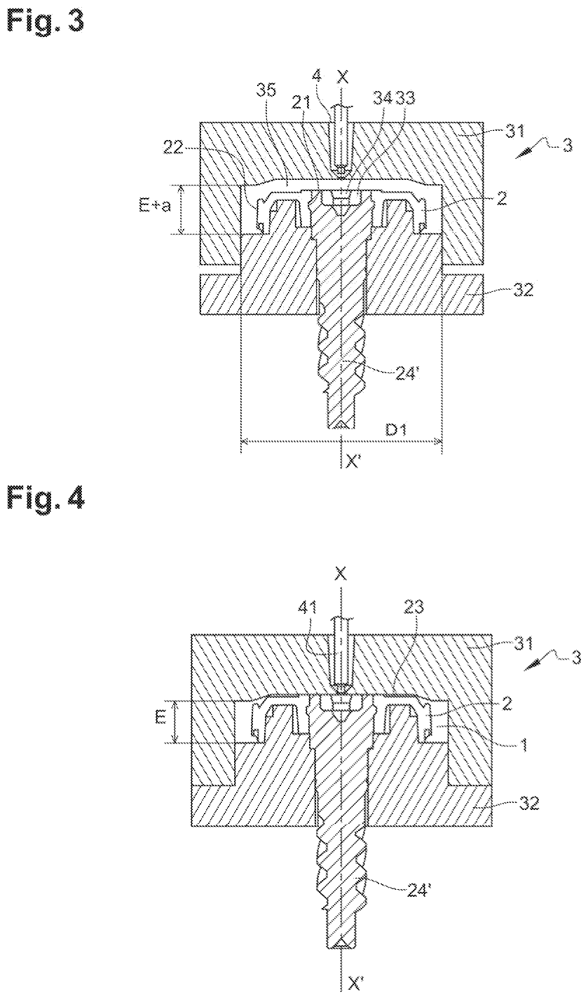

FIG. 3 is a schematic representation of a step of making of a rim when an injection material is injected according to a second embodiment.

FIG. 4 is a schematic representation of the step of making a rim when the injection material of FIG. 3 is compressed.

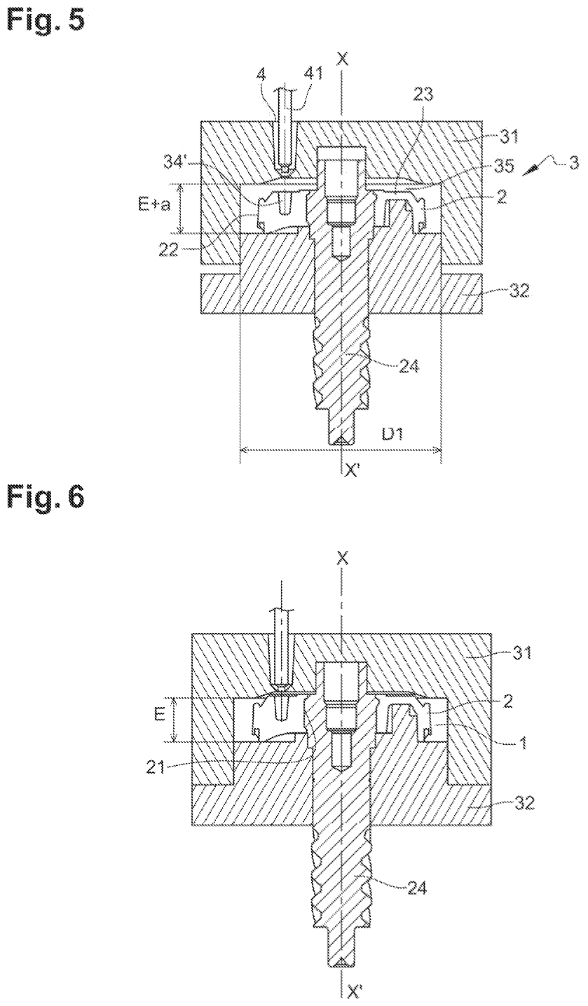

FIG. 5 is a schematic representation of a step of making a rim when an injection material is injected according to a third embodiment.

FIG. 6 is a schematic representation of the step of making a rim when the injection material of FIG. 5 is compressed.

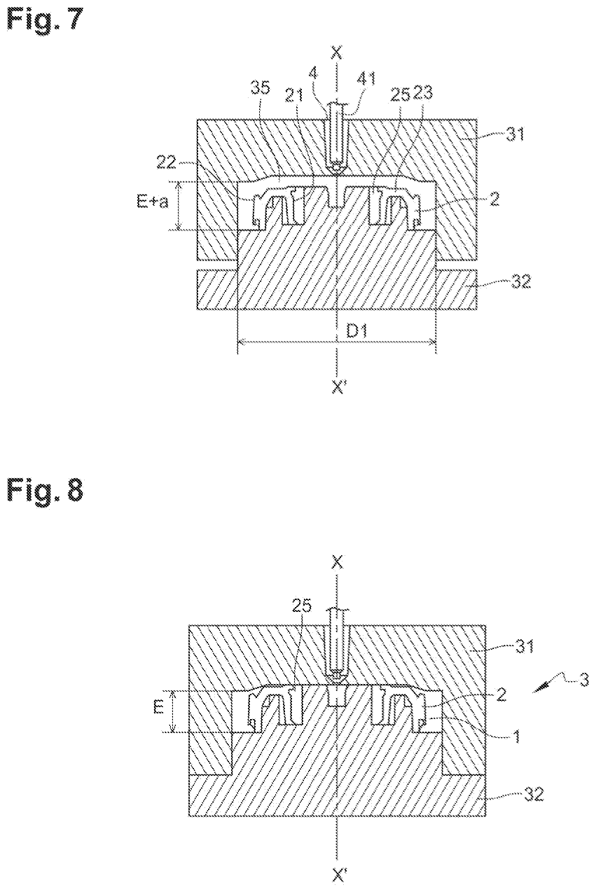

FIG. 7 is a schematic representation of a step of making a rim when an injection material is injected according to a fourth embodiment.

FIG. 8 is a schematic representation of the step of making a rim when the injection material of FIG. 7 is compressed.

The present invention concerns a method for manufacturing a wheel.

Said wheel may in particular be a toothed wheel of gear reducer, and more particularly a reducer wheel for power steering, and may for example form a worm wheel intended to be driven by a worm screw. The toothed wheel may have any type of meshing teeth, for example forming a straight toothing, a helical toothing, or a herringbone toothing. Although the invention is not limited to a wheel of particular dimensions, it will be noted that, in the context in particular of a wheel intended for a power steering reduction gear, the diameter D1 of said wheel may be substantially comprised between 30 mm and 200 mm, more particularly between 50 mm and 150 mm, and preferably equal to 100 mm.

The method comprises a step of making a rim 1 on a peripheral edge of the wheel, during this step a carrier core 2 is placed, which extends from a radially inner wall 21 forming a steering axis (XX′) bore, corresponding to the axis of rotation of the wheel, until a radially outer peripheral edge 22, in a mold 3 formed by a first portion 31 and a second portion 32.

The steering axis (XX′) corresponds in practice to the axis of rotation of the wheel, and is advantageously common to the different constituent elements of said wheel.

For convenience of description, the term «axial», will denote a direction or a dimension considered along said steering axis (XX′) or parallel to the latter, and «radial», will denote a direction or a dimension considered transversely, and more particularly perpendicularly, to said steering axis (XX′).

The carrier core 2 includes a hub, with a steering axis (XX′), as well as a skirt 23 which extends substantially radially from said hub, moving away from the steering axis (XX′), until a peripheral edge 22. The rim 1 is formed on this peripheral edge 22.

An upper surface of the carrier core, or of the skirt 23, will correspond herein in practice to the apparent surface intended to receive a coating layer (while the opposite lower surface is preferably intended to remain exposed, without a layer of coating), said upper surface being, to this end, oriented axially on the material inlet side, that is to say opposite the injection nozzle.

The upper face extends radially continuously, i.e. without a groove extending along the steering axis (XX′) of the wheel, from the radially inner wall 21 until the peripheral edge 22.

The upper face extends in a plane substantially transverse to the steering axis (XX′).

The upper face extends opposite the first portion 31 of the mold 3, and a gap between the first portion 31 of the mold 3 and the upper face when the two portions of the mold 3 are brought closer to each other is less than 1 mm.

The peripheral edge 22 comprises a plurality of grooves extending along the steering axis (XX′) of the wheel.

In FIGS. 1, 2, 5 and 6, the hub of the carrier core 2 includes a shaft 24 which in particular protrudes from the upper surface.

In FIGS. 3 and 4, the hub of the carrier core 2 includes a shaft 24′ which is flush with the upper surface.

In FIGS. 7 and 8, the hub of the carrier core 2 includes a sleeve 25 which is flush with the upper surface.

The mold 3 is formed by a first portion 31 and a second portion 32 movable in translation with respect to the first portion 31. According to a relative position of the first portion 31 with respect to the second portion 32, two distinct positions of the mold 3 are determined: an injection position and a fully closed position.

FIGS. 1, 3, 5 and 7 represent the mold 3 in an injection position.

FIGS. 2, 4, 6 and 8 represent the mold 3 in a fully closed position.

After having placed the carrier core 2 in the mold 3, if necessary, an injection shield 33 which is intended to protect an area of the carrier core 2 or of the bore is positioned then a coating layer in a polymer injection material is made by overmolding on the carrier core 2, The coating layer is intended to remain permanently on the finished wheel (that is to say that said coating layer is not removed, or at least not entirely removed, by machining after having been formed on the carrier core 2, so as to be retained on the final wheel, within which said coating layer has in particular a functional role of structural reinforcement).

The injection shield 33 makes it possible to avoid the injection of the injection material in some areas of the carrier core 2 or of the bore.

In FIGS. 1 and 2, the injection shield 33 has a conical shape which covers the whole hub and a portion of the carrier core 2 so that the injection material is guided, during injection towards the peripheral edge 22 of the carrier core 2 and therefore towards the peripheral edge of the wheel. The injection shield 33 comprises a recess 34 in its center intended to collect the cold drop.

In FIGS. 3 and 4, the injection shield 33 is a disc which covers a portion of the hub such that the injection material does not fill said hub. The injection shield 33 comprises a recess in its center intended to collect the cold drop.

The overmolding is carried out by an injection method using an injection nozzle 4 when the mold 3 is in the injection position. In this position, there is a void 35 between the first portion 31 of the mold and the carrier core 2 or the injection shield 33. This void 35 allows a proper flow of the injection material during the injection. In the injection position, an axial thickness E+a of the rim 1 is then greater than the axial thickness E of the rim 1 in the final wheel.

In FIGS. 1, 2, 3, 4, 7 and 8, the injection nozzle 4 has an injection point positioned along the steering axis (XX′) of the wheel.

In FIGS. 5 and 6, the injection nozzle 4 has an injection point positioned radially offset from the steering axis (XX′) of the wheel. The injection nozzle 4 is located opposite a trapping cavity 34′ formed by a blind hole in the carrier core 2 from the upper surface.

The injection nozzle 4 comprises a shutter 41 which closes the injection nozzle 4 when the first portion 31 of the mold 3 is brought closer to the second portion 32 of the mold 3.

After the injection of the injection material, the first portion 31 of the mold 3 is translatably brought closer to the second portion 32 of the mold 3 so that the void 35 no longer exists. The injection material is then compressed in the mold 3. The axial thickness E of the rim 1 then has its final dimension.

By this method, there is less material wasted than in the state of the art.

Of course, the invention is not limited to the embodiments described and represented in the appended figures. Modifications are still possible, in particular with regards to the constitution of the various elements or by substitution with technical equivalents, yet without departing from the scope of protection of the invention.

1. A method for manufacturing a wheel, the method comprising a step of making a rim on a radially outer peripheral edge of a carrier core, during the step, said carrier core, which extends from a radially inner wall forming a steering axis bore, corresponding to the axis of rotation of the wheel, until the peripheral edge, is placed in a mold formed by at least one first portion and one second portion, then an injection material is injected by means of at least one injection nozzle so as to coat, by overmolding, at least partially said carrier core in order to form the wherein after the injection of the injection material, the first portion of the mold and the second portion of the mold are brought closer to each other such that the injection material is compressed in the mold.

2. The method for manufacturing a wheel according to claim 1, wherein the injection nozzle comprises a shutter making it possible to clog the injection nozzle when the first portion of the mold is brought closer to the second portion of the mold.

3. The manufacturing method according to claim 1, wherein the first portion of the mold is brought closer to the second portion of the mold by a translational movement.

4. The method for manufacturing a wheel according to claim 1, wherein the injection nozzle has an injection point positioned along the steering axis of the bore.

5. The method for manufacturing a wheel according to claim 4, wherein the injection point is located opposite an injection shield intended to protect at least one area of the carrier core or of the bore.

6. The method for manufacturing a wheel according to claim 1, wherein the injection nozzle has at least one injection point positioned radially offset from the steering axis of the bore.

7. The method for manufacturing a wheel according to claim 6, wherein the injection point is positioned opposite a trapping cavity formed in the carrier core.

8. The method for manufacturing a wheel according to claim 1, wherein the mold comprises recesses making it possible to directly form meshing teeth on the rim.

9. The method for manufacturing a wheel according to claim 1, wherein the rim has an axial thickness comprised between 1 and 3 cm.

10. The method for manufacturing a wheel according to claim 1, wherein an upper face of the carrier core which faces the injection nozzle, extends radially continuously from the radially inner wall to the peripheral edge.
